(19) United States
(12) Patent Application Publication
(10) Pub. No.: US 2016/0118832 A1
(43) Pub. Date: Apr. 28, 2016

(54) APPARATUS FOR CHARGING AND DISCHARGING BATTERY

(71) Applicant: Beyond Innovation Technology Co., Ltd., Taipei City (TW)

(72) Inventors: Zhen-Chun Liu, Taipei City (TW); Ming-Chi Sun, Taipei City (TW)

(21) Appl. No.: 14/818,327

(22) Filed: Aug. 5, 2015

(30) Foreign Application Priority Data
Oct. 27, 2014 (TW) 103136999

(51) Int. Cl. H02J 7/00

(52) U.S. Cl. CPC H02J 7/0077

(57) ABSTRACT

An apparatus for charging and discharging a battery is provided, in which the apparatus includes a charging unit, a detecting unit and a discharging unit. The charging unit charges the battery in response to a charging voltage coupled to a voltage input terminal of the charging unit. The detecting unit detects a coupled state between the charging voltage and the charging unit, and turns on a discharging path provided by the discharging unit when the charging voltage is moved away from the charging unit, so as to make the battery supply power to a load. The detecting unit turns off the discharging path when the charging voltage is coupled to the charging unit, so that the battery can not supply power to the load.

### CROSS-REFERENCE TO RELATED APPLICATION

This application claims the priority benefit of Taiwan application serial no. 103136999, filed on Oct. 27, 2014. The entirety of the above-mentioned patent application is hereby incorporated by reference herein and made a part of this specification.

### BACKGROUND OF THE INVENTION

1. Field of the Invention

The invention relates to an electronic apparatus, more particularly, to an apparatus for charging and discharging a battery.

2. Description of Related Art

With the development of technology, the battery has become an indispensable source of electricity for portable electronic devices. Portable electronic devices, such as a MP3 walkman, a mobile phone, or a notebook computer, all may use the battery as the main source of electricity.

Currently, power supplies for portable electronic devices can be divided into two main types. One type of power supplies is external power supply. The other type of power supplies is battery. Because the portable electronic devices are generally used outdoors under the condition that connecting to an external power supply is not an option, the portable electronic device is only electrically supplied by battery installed inside. Therefore, the battery is the most important and a main source of electricity to supply for the portable electronic devices. Currently, battery charge and discharge are generally controlled by the control chip installed inside the portable electronic device. However, this method makes the circuit structure become more complex, and the cost in manufacturing become higher.

### SUMMARY OF THE INVENTION

The invention provides an apparatus for charging and discharging a battery, the apparatus has charging and discharging circuits that are effectively simplified, so as to reduce the cost in manufacturing.

The apparatus for charging and discharging a battery in the invention includes a charging unit, a detecting unit, and a discharging unit. To be more specific, the charging unit is coupled to a battery and charges the battery in response to a charging voltage coupled to a voltage input terminal of the charging unit. The detecting unit is coupled to the voltage input terminal of the charging unit and detects a coupled state between the charging voltage and the charging unit. The discharging unit is coupled to the detecting unit and a load, and the detecting unit turns on a discharging path provided by the discharging unit when the charging voltage is moved away from the charging unit, so as to make the battery supply power to a load. The detecting unit turns off the discharging path when the charging voltage is coupled to the charging unit, so that the battery can not supply power to the load.

Based on the above, the charging unit and the discharging unit in the embodiment of the invention can directly control the battery charge and discharge in response to the charging voltage that is coupled to the voltage input terminal of the charging unit. Therefore, using an additional control chip to control the battery charge and discharge is no longer necessary, and thus the charging and discharging circuits are effectively simplified, so as to reduce the cost in manufacturing and procurement of the apparatus for charging and discharging a battery.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an apparatus for charging and discharging a battery of one embodiment of the invention.

FIG. 2 is a circuit diagram of the apparatus for charging and discharging a battery of one embodiment of the invention.

### DESCRIPTION OF THE EMBODIMENTS

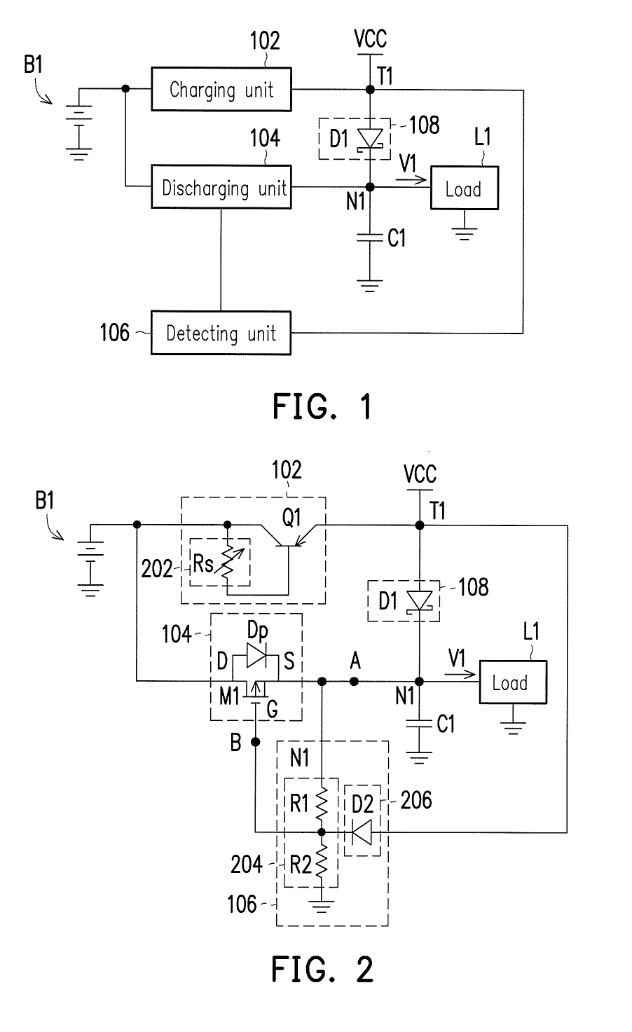

FIG. 1 is a schematic diagram of an apparatus for charging and discharging a battery of one embodiment of the invention. Referring to FIG. 1, an apparatus for charging and discharging a battery includes a charging unit 102, a discharging unit 104, a detecting unit 106, a rectification unit 108, and a capacitor C1. The anode and cathode of the rectification unit 108 are respectively coupled to a voltage input terminal T1 of the charging unit 102 and a load L1. The capacitor C1 is coupled between the cathode of the rectification unit 108 and the ground. In this embodiment, the rectification unit 108 is a Schottky diode D1, but the invention is not limited thereto. In addition, the charging unit 102 is coupled to a battery B1 and charges the battery B1 in response to a charging voltage VCC which is coupled to the voltage input terminal T1 of the charging unit 102. The battery B1 can be, for example, a lithium battery, but the invention is not limited thereto. The discharging unit 104 is coupled to the detecting unit 106, the battery B1, and the common node N1 of the rectification unit 108 and the capacitor C1. The detecting unit 106 is further coupled to the voltage input terminal T1 of the charging unit 102.

To be more specific, the charging unit 102 can directly charge the battery B1 in response to the charging voltage VCC which is coupled to the voltage input terminal T1 of the charging unit 102. Simultaneously, the charging voltage VCC can provide the power supply voltage V1 for the load L1 through the rectification unit 108 (Schottky diode D1). Otherwise, the detecting unit 106 can detect whether the voltage input terminal T1 of the charging unit 102 is coupled to the charging voltage VCC. The detecting unit 106 turns on a discharging path provided by the discharging unit 104 when the charging voltage VCC is moved away from the charging unit 102, so as to make the battery B1 supply power to a load L1 through the discharging path. On the contrary, the detecting unit 106 turns off the discharging path when the charging voltage VCC is coupled to the charging unit 102, so that the battery B1 can not supply power to the load L1. Therefore, the charging unit 102 and/or the discharging unit 104 are directly combined with the charging voltage VCC, which is coupled to the voltage input terminal T1 of the charging unit 102, to charge and to discharge the battery B1. Consequently, the conventional technique that using an additional control chip to control the charging and discharging of the battery B1 is no longer necessary, and thus the charging and discharging circuits are effectively simplified, so as to reduce the cost in manufacturing and procurement of the apparatus for charging and discharging a battery.

FIG. 2 is a circuit diagram of the apparatus for charging and discharging a battery of one embodiment of the invention. Referring to FIG. 2, the charging unit 102 in this embodiment includes a PNP bipolar junction transistor Q1 and a current-limiting unit 202. The emitter of the PNP bipolar junction transistor Q1 is coupled to the voltage input terminal T1 of the charging unit 102, and the collector of the PNP bipolar junction transistor Q1 is coupled to the battery B1. In addition, the current-limiting unit 202 is coupled between the base and the collector of the PNP bipolar junction transistor Q1. In this embodiment, the current-limiting unit 202 can be, for example, an adjustable resistor Rs, but the invention is not limited thereto. Furthermore, the discharging unit 104 in this embodiment can be a p-type metal oxide semiconductor transistor M1 which has a drain coupled to the battery B1, a source coupled to the common node N1 of the rectification unit 108 and the capacitor C1, and the gate coupled to the detecting unit 106. In addition, the p-type metal oxide semiconductor transistor M1 has a parasitic diode Dp, the anode and the cathode of the parasitic diode Dp are respectively coupled to the drain and the source of the p-type metal oxide semiconductor transistor M1.

Otherwise, the detecting unit 106 in this embodiment includes a voltage divider unit 204 and a rectification unit 206, the voltage divider unit 204 is coupled between the ground and the common node N1 of the rectification 108 unit and the capacitor C1. The voltage divider unit 204 can divide the power supply voltage V1, and thus a part of the power supply voltage V1 is generated to supply to the gate of the p-type metal oxide semiconductor transistor M1. The anode and the cathode of the rectification unit 206 are respectively coupled to the voltage input terminal T1 of the charging unit 102 and the gate of the p-type metal oxide semiconductor transistor M1. In this embodiment, the voltage divider unit 204 can be resistors R1 and R2, and the resistors R1 and R2 are serially connected in between the ground and the common node N1. The common node of the resistors R1 and R2 is coupled to the gate of the p-type metal oxide semiconductor transistor. Otherwise, the rectification unit 206 in this embodiment can be a rectifier diode D2.

When the charging voltage VCC is coupled to the charging unit 102, the charging voltage VCC can supply the power supply voltage V1 to the load L1 through the rectification unit 108 (the Schottky diode D1) and simultaneously charge the battery B1 through the PNP bipolar junction transistor Q1. To be more specific, the battery B1 is charged by the collector current of the PNP bipolar junction transistor Q1. The value of the collector current of the PNP bipolar junction transistor Q1 can be adjusted by the adjustable resistor Rs. Specifically, when the value of the adjustable resistor Rs increases, the value of the base current and the collector current of the PNP bipolar junction transistor Q1 decreases. Therefore, the value of the adjustable resistor Rs can be adjusted to be greater or smaller according to the actual requirement, so that the charging current (the collector current of the PNP bipolar junction transistor Q1) can conforms to the specifications of the battery B1.

In addition, the p-type metal oxide semiconductor transistor M1 is in a cut-off state when the charging voltage VCC is coupled to the charging unit 102. For example, assuming that the value of the charging voltage VCC is 5V, the turn-on voltage value of the Schottky diode D1 is 0.3V, the turn-on voltage value of the rectifier diode D2 is 0.7V, and the threshold voltage value of the p-type metal oxide semiconductor transistor is 1V. When the charging voltage VCC is coupled to the charging unit 102, the gate voltage value of the p-type metal oxide semiconductor transistor M1 is 4.3 V, and the source voltage value of the p-type metal oxide semiconductor transistor M1 is 4.7V(5V−0.3V=4.7V), the voltage difference between the gate and the source of the p-type metal oxide semiconductor transistor M1 is 0.4V which is smaller than the threshold voltage (1V) of the p-type metal oxide semiconductor transistor M1, and thus the p-type metal oxide semiconductor transistor M1 is in cut-off state.

Otherwise, when the charging voltage VCC is removed from the voltage input terminal T1 of the charging unit 102, the battery B1 can charge the load L1 through the p-type metal oxide semiconductor transistor M1, so as to provide the power supply voltage V1 to the load L1. For example, assuming that the saturation voltage of the battery B1 is 4.2V, the turn-on voltage value of the parasitic diode Dp of the p-type metal oxide semiconductor transistor is 0.7V, and the values of the resistors R2 and R1 are the same. When the charging voltage VCC is removed, the voltage values at the terminal A and the terminal B of the p-type metal oxide semiconductor transistor M1 are around 3.5V and 1.75V respectively, and thus the voltage difference between two terminals A and B is 1.75V which is greater than the threshold voltage (1V) of the p-type metal oxide semiconductor transistor M1. Therefore, the p-type metal oxide semiconductor transistor M1 is in conducting state, so that the battery B1 can provide the power supply voltage V1 to the load L1 through the p-type metal oxide semiconductor transistor M1.

In summary, the charging unit and the discharging unit in the embodiment of the invention can directly control the battery charge and discharge in response to the charging voltage which is coupled to the voltage input terminal of the charging unit. Therefore, the target that controlling the battery charge and discharge is achieved by simpler circuits, the conventional technique that using an additional control chip to control the battery charge and discharge is no longer necessary, and the charging and discharging circuits are more effectively simplified compared to the conventional technique, so as to reduce the cost in manufacturing and procurement of the apparatus for charging and discharging a battery.

What is claimed is:

1. An apparatus for charging and discharging a battery, comprising:
a charging unit, coupled to a battery, charging the battery in response to a charging voltage coupled to a voltage input terminal of the charging unit;
a detecting unit, coupled to the voltage input terminal of the charging unit, detecting a coupled state between the charging voltage and the charging unit; and
a discharging unit, coupled to the detecting unit and a load, wherein the detecting unit turns on a discharging path provided by the discharging unit when the charging voltage is moved away from the charging unit, so as to make the battery supply power to a load, and the detecting unit turns off the discharging path when the charging voltage is coupled to the charging unit, so that the battery can not supply power to the load.

2. The apparatus for charging and discharging a battery as recited in claim 1, wherein the charging unit comprises:
a PNP bipolar junction transistor, having an emitter coupled to the voltage input terminal of the charging unit, a collector coupled to the battery; and
a current-limiting unit, coupled between a base and the collector of the PNP bipolar junction transistor.

3. The apparatus for charging and discharging a battery as recited in claim 2, wherein the current-limiting unit comprises an adjustable resistor.

4. The apparatus for charging and discharging a battery as recited in claim 1, further comprising:
a first rectification unit, having an anode and a cathode respectively coupled to the voltage input terminal of the charging unit and the load; and
a capacitor, coupled between the cathode of the first rectification unit and a ground, a common node of the first rectification unit and the capacitor providing a power supply voltage to the load response the charging voltage.

5. The apparatus for charging and discharging a battery as recited in claim 4, wherein the first rectification unit comprises a Schottky diode.

6. The apparatus for charging and discharging a battery as recited in claim 4, wherein the discharging unit comprises:
a p-type metal oxide semiconductor transistor, having a drain coupled to the battery, a source coupled to the common node of the first rectification unit and the capacitor, and a gate coupled to the detecting unit, wherein the p-type metal oxide semiconductor transistor further has a parasitic diode, an anode and a cathode of the parasitic diode are respectively coupled to the drain and the source of the p-type metal oxide semiconductor transistor.

7. The apparatus for charging and discharging a battery as recited in claim 6, wherein the detecting unit comprises:
a voltage divider unit, coupled between the ground and the common node of the first rectification unit and the capacitor, dividing the power supply voltage, a part of the power supply voltage supplied to the gate of the p-type metal oxide semiconductor transistor; and
a second rectification unit, wherein an anode and a cathode of the second rectification unit are respectively coupled to the voltage input terminal of the charging unit and the gate of the p-type metal oxide semiconductor transistor.

8. The apparatus for charging and discharging a battery as recited in claim 7, wherein the voltage divider unit comprises:
a first resistor; and
a second resistor, together with the first resistor serially connected in between the ground and the common node of the first rectification unit and the capacitor, wherein a common node of the first resistor and the second resistor is coupled to the gate of the p-type metal oxide semiconductor transistor and the cathode of the second rectification unit.

9. The apparatus for charging and discharging a battery as recited in claim 7, wherein the second rectification unit comprises a rectifier diode.
